(19) United States
(12) Patent Application Publication
(10) Pub. No.: US 2009/0270582 A1
(43) Pub. Date: Oct. 29, 2009

(54) HYPER-BRANCHED POLYURETHANES METHOD FOR PRODUCTION AND USE THEREOF

(75) Inventors: Matthias Seiler, Griesheim (DE); Stefan Bernhardt, Offenbach (DE); Markus Schwarz, Haltern am See (DE); Friedrich Georg Schmidt, Haltern am See (DE); Werner Freitag, Dorsten (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/296,168

(22) PCT Filed: Apr. 3, 2007
(86) PCT No.: PCT/EP2007/053243

§ 371 Date: Oct. 6, 2008

(30) Foreign Application Priority Data
May 9, 2006 (DE) 10 2006 021 779.9

(51) Int. Cl. C08G 18/72

(52) U.S. Cl. 528/60

(57) ABSTRACT

A hyperbranched polyurethane which is obtainable by reacting a diisocyante or polyisocyanate with a triol of the formula (1)

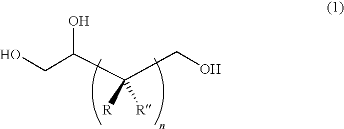

where R and R″ each independently of one another are hydrogen or an alkyl group having 1 to 4 carbon atoms and where n is an integer greater than 2 and which has a numerical average of at least 4 repeating units of the formula (2) per molecule.

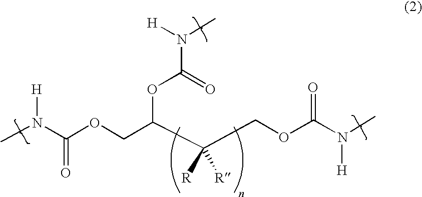

The present invention relates to hyperbranched polyurethanes, to processes for preparing them and to their use.

Hyperbranched polymers are already known. C. Gao Hyperbranched polymers: from synthesis to applications Prog. Polym. Sci. 29 (2004) 183-275 summarizes the present state of the art in this field and deals in particular with the different synthesis variants and the different fields of application of hyperbranched polymers. One of the subjects discussed is the use of isophorone diisocyanate for preparing hyperbranched polyurethanes.

EP 1 026 185 A1 discloses a process for preparing dendritic or highly branched polyurethanes by reacting diisocyanates and/or polyisocyanates with compounds having at least two isocyanate-reactive groups, at least of the reaction partners containing functional groups with a reactivity which is different from that of the other reaction partner, and the reaction conditions being selected such that only particular reactive groups react with one another in each reaction step.

Preferred isocyanates include aliphatic isocyanates, such as isophorone diisocyanate. Examples of the compounds having at least two isocyanate-reactive groups are, by name, propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol and tris(hydroxymethyl)amino-methane.

The polyurethanes obtainable by the process are intended to serve as crosslinkers for polyurethanes or as building blocks for other polyaddition or polycondensation polymers, as phase mediators, thixotropic agents, nucleating reagents or as active-substance carriers or catalyst supports.

DE 100 30 869 A1 describes a process for preparing polyfunctional polyisocyanate polyaddition products, comprising
(i) preparing an addition product (A) by reacting
   a) an at least trifunctional component (a1) which is reactive with isocyanate groups, or a difunctional component (a2) which is reactive with isocyanate groups, or a mixture of components (a1) and (a2), with
   b) diisocyanate or polyisocyanate, the reaction ratio being selected such that the addition product (A) contains on average one isocyanate group and more than one group which is reactive with isocyanate groups,
(ii) subjecting the addition product (A), if desired, to intermolecular addition reaction to give a polyaddition product (P) which contains on average one isocyanate group and more than two groups which are reactive with isocyanate groups, and
(iii) reacting the addition product (A) or the polyaddition product (P) with an at least difunctional component (c) which is reactive with isocyanate groups.

Examples given for the compound (a) include glycerol, trimethylolmethane and 1,2,4-butanetriol. A preferred diisocyanate (b) is isophorone diisocyanate.

The polyisocyanate polyaddition products obtainable by the process are proposed in particular for the preparation of coating materials, coverings, adhesives, sealants, casting elastomers and foams.

WO 2004/101624 discloses the preparation of dendritic or hyperbranched polyurethanes by
1) reacting diols or polyols containing at least one tertiary nitrogen atom and at least two hydroxyl groups having different reactivity towards isocyanate groups with diisocyanates or polyisocyanates, such as isophorone diisocyanate, to give an addition product, the diols or polyols and diisocyanates or polyisocyanates being selected such that the addition product contains on average one isocyanate group and more than one hydroxyl group, or one hydroxyl group and more than one isocyanate group.
2) reacting the addition product from step 1) to give a polyaddition product, by intermolecular reaction of the hydroxyl groups with the isocyanate groups, it also being possible for reaction to take place first of all with a compound containing at least two hydroxyl groups, mercapto groups, amino groups or isocyanate groups,
3) if desired, reacting the polyaddition product from step 2) with a compound containing at least two hydroxyl groups, mercapto groups, amino groups or isocyanate groups.

The polyaminourethanes obtainable by the process are proposed as crosslinkers for polyurethane systems or as building blocks for other polyaddition or polycondensation polymers, as phase mediators, as rheological assistants, as thixotropic agents, as nucleating reagents or as active-substance carriers or catalyst supports.

WO 02/068553 A2 describes a coating composition comprising
1) a carbamate resin having a hyperbranched or star-shaped polyol core, with a first chain section based on a polycarboxylic acid or a polycarboxylic anhydride, with a second chain section based on an epoxide, and with carbamate groups on the core and/or the second chain section, and
2) a second resin containing reactive groups which are able to react with the carbamate groups of the carbamate resin.

The polyol core can be obtained by reacting a first compound, containing more than 2 hydroxyl groups, such as 1,2,6-hexanetriol, with a second compound, containing a carboxyl group and at least two hydroxyl groups.

The carbamate groups can be introduced by reaction with aliphatic or cycloaliphatic diisocyanates. As part of a relatively long listing, isocyanates specified in this context include 2,2,4- and 2,4,4-trimethyl-1,6-diisocyanatohexane and isophorone diisocyanate.

WO 97/02304 relates to highly functionalized polyurethanes composed of molecules with the functional groups A(B)ₙ, with A being an NCO group or a group which is reactive with an NCO group, B being an NCO group or a group which is reactive with an NCO group, A being reactive with B, and n being a natural number which is at least 2. The monomer A(B)ₙ can be prepared, for example, starting from isophorone diisocyanate.

The performance of the above polymers, however, is still not sufficient for numerous applications; often, when using these polymers, the resulting scratch resistance, flexibility or chemical resistance is too low and/or the resulting permeability and/or friction coefficient is too high.

In view of this prior art it was an object of the present invention to provide hyperbranched polymers which have an improved profile of properties and which can be employed with preference for the purpose of achieving at least one, more preferably as many as possible, of the following objectives:

[symbol]

a very high scratch resistance, [symbol]
a very high flexibility, [symbol]
a very high chemical resistance, [symbol]
a very low permeability, [symbol]
a very low friction coefficient.

The hyperbranched polymers ought to be able to be prepared extremely simply on an industrial scale. A further intention is to demonstrate particularly favourable fields of application of the hyperbranched polymers.

These objects and also others which, although not specified explicitly, are nevertheless self-evidently inferable from the circumstances discussed herein or result inevitably from them, are achieved by the hyperbranched polyurethane described in claim 1. Judicious modifications of these polyurethanes are protected in the subclaims that refer back to these claims. The further claims describe particularly suitable fields of application of the hyperbranched polyurethane of the invention.

The present invention accordingly provides a hyperbranched polyurethane which is obtainable by reacting a diisocyanate or polyisocyanate with a triol of the formula (I)

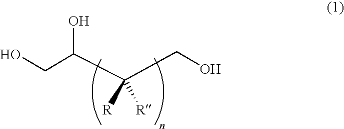

where R and R″ each independently of one another are hydrogen or an alkyl group having 1 to 4 carbon atoms and where n is an integer greater than 2,
and if desired with at least one further diol or polyol,
the polyurethane having a numerical average of at least 4 repeating units of the formula (2) per molecule.

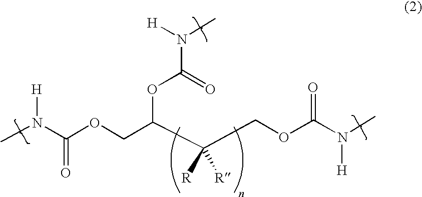

Through the provision of the hyperbranched polyurethane of the invention, success is achieved, in a surprising way, in making available a hyperbranched polymer having a markedly improved performance profile, which, as an additive in the corresponding compositions, makes possible a substantial improvement in

[symbol]

scratch resistance, [symbol]
flexibility, [symbol]
chemical resistance, [symbol]
permeability and/or [symbol]
friction coefficient.

At the same time the hyperbranched polyurethane of the invention is available in a simple way, on an industrial scale and at comparatively favourable cost.

Highly branched globular polymers are referred to in the technical literature by terms which include that of “dendritic polymers”. These dendritic polymers, synthesized from polyfunctional monomers, can be divided into two different categories, the “dendrimers” and the “hyperbranched polymers”. Dendrimers possess highly regular, radially symmetric generation structure. They represent monodisperse globular polymers which, in comparison to hyperbranched polymers, are prepared in multistep syntheses with a high degree of synthetic complexity. The structure in this case is characterized by three different areas: the polyfunctional core, which represents the centre of symmetry; different, well-defined radially symmetric layers of one repeating unit (generation); and the terminal groups. In contrast to the dendrimers, the hyperbranched polymers are polydisperse and are irregular in terms of their branching and structure. Besides the dendritic units and terminal units, hyperbranched polymers differ from dendrimers in containing linear units as well. An example of a dendrimer and of a hyperbranched polymer, constructed from repeating units which in each case contain at least three bonding possibilities, is shown respectively in the following structures:

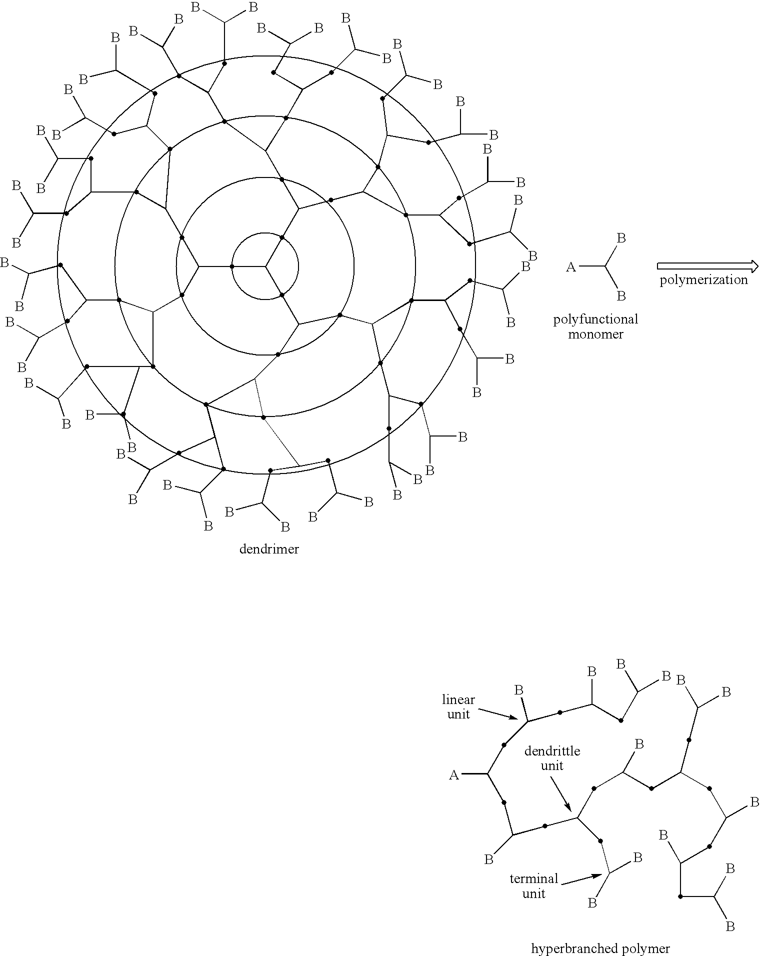

With respect to the various possibilities relating to the synthesis of dendrimers and hyperbranched polymers, reference may be made in particular to
a) Fréchet J. M. J., Tomalia D. A. “Dendrimers And Other Dendritic Polymers” John Wiley & Sons, Ltd., West Sussex, UK 2001 and also
b) Jikei M., Kakimoto M. “Hyperbranched Polymers: A Promising New Class Of Materials” Prog. Polym. Sci., 26 (2001) 1233-85 and/or
c) Gao C., Yan D. “Hyperbranched Polymers: From Synthesis To Applications” Prog. Polym. Sci., 29 (2004) 183-275,
   which are hereby introduced as references and are considered part of the disclosure content of the present invention.

The present invention relates to a hyperbranched polyurethane which is obtainable by reacting a diisocyanate or polyisocyanate with a triol of the formula (I).

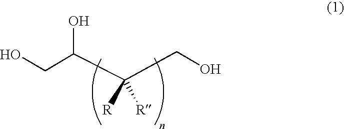

In this formula the radicals R and R″ each independently of one another are hydrogen or an alkyl group having 1 to 4 carbon atoms, preferably methyl, ethyl, n-propyl, isopropyl, n-butyl, 2-butyl or tert-butyl. In one especially preferred embodiment of the present invention R and R″ are hydrogen.

n is an integer greater than 2, more preferably in the range from 3 to 10. In one particularly preferred version of the invention n is 3.

The hyperbranched polyurethane is further characterized in that it has a numerical average of at least 4, preferably of at least 50, more preferably at least 200, very preferably at least 400 repeating units of the formula (2) per molecule.

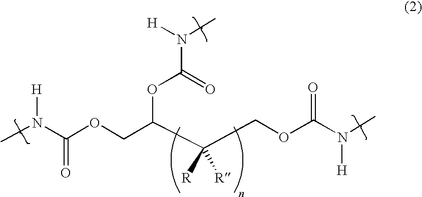

The upper limits on repeating units of the formula (2) is favourably 10 000, preferably 5000 and in particular 2500 repeating units, based in each case on the numerical average.

The diisocyanates and polyisocyanates used in accordance with the invention may be composed of any desired aromatic, aliphatic, cycloaliphatic and/or (cyclo)aliphatic diisocyanates and/or polyisocyanates.

Suitable aromatic diisocyanates or polyisocyanates include in principle all known compounds. Particular suitability is possessed by phenylene 1,3- and 1,4-diisocyanate, naphthylene 1,5-diisocyanate, tolidine diisocyanate, tolylene 2,6-diisocyanate, tolylene 2,4-diisocyanate (2,4-TDI), diphenylmethane 2,4′-di-isocyanate (2,4′-MDI), diphenylmethane 4,4′-diisocyanate, the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene.

Suitable aliphatic diisocyanates or polyisocyanates possess advantageously 3 to 16 carbon atoms, preferably 4 to 12 carbon atoms, in the linear or branched alkylene radical, and suitable cycloaliphatic or (cyclo)aliphatic diisocyanates possess advantageously 4 to 18 carbon atoms, preferably 6 to 15 carbon atoms, in the cycloalkylene radical. By (cyclo)aliphatic diisocyanates the skilled person means NCO groups which are sufficiently attached cyclically and aliphatically at the same time, as is the case, for example, for isophorone diisocyanate. By cycloaliphatic diisocyanates, in contrast, are meant those which contain only NCO groups attached directly to the cycloaliphatic ring, an example being H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyloctane 1,8-diisocyanate (TIN), decane diisocyanate and triisocyanate, undecane diisocyanate and triisocyanate, and dodecane diisocyanates and triisocyanates.

Preference is given to isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/-2,4,4-trimethylhexamethylene diisocyanate (TMDI), and norbornane diisocyanate (NBDI). Very particular preference is given to using IPDI, HDI, TMDI and H₁₂MDI, with the use of the isocyanurates also being possible.

Likewise suitable are 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, methylenebis-(cyclohexyl) 2,4′-diisocyanate and 1,4-diisocyanato-4-methylpentane.

It is of course also possible to use mixtures of the diisocyanates and polyisocyanates.

In addition it is preferred to use oligoisocyanates or polyisocyanates which can be prepared from the aforementioned diisocyanates or polyisocyanates, or mixtures thereof, by linking by means of urethane, allophanate, urea, biuret, uretdione, amide, isocyanurate, carbodiimide, uretonimine, oxadiazinetrione or iminooxadiazinedione structures. Particular suitability is possessed by isocyanurates, especially those of IPDI and HDI.

Preferred triols of the formula (1) comprise, in particular, 1,2,5-pentanediol, 1,2,6-hexanetriol, 1,2,7-heptanetriol, 1,2,8-octanetriol, 1,2,9-nonane-triol and 1,2,10-decanetriol, with 1,2,6-hexanetriol being especially preferred.

In one particularly preferred embodiment of the present invention the polyurethane is obtainable by reacting a diisocyanate or polyisocyanate with a triol of the formula (1) and at least one diol. Diols which are particularly favourable in this context comprise ethylene glycol, diethylene glycol, triethylene glycol, polyethylene glycol, propylene glycol, dipropylene glycol, tripropylene glycol, polypropylene glycol, 1,2-propanediol, 1,2-butanediol and/or 1,3-butanediol.

The mixture of triol of the formula (1) and diol contains, based in each case on its total weight, preferably 50.0% to <100.0% by weight of triol of the formula (1) and >0.0% to 50.0% by weight of diol, more preferably 50.0% to 75.0% by weight of triol of the formula (1) and 25.0% to 50.0% by weight of diol.

The hyperbranched polyurethane of the invention preferably has a weight-average molecular weight Mw in the range from 1000 g/mol to 200 000 g/mol, more favourably in the range from 1500 g/mol to 100 000 g/mol, with particular preference in the range from 2000 g/mol to 75 000 g/mol, and in particular in the range from 2500 g/mol to 50 000 g/mol.

The determination of the molecular weight, particularly the determination of the weight-average molecular weight Mw and the number-average molecular weight, can be measured in a way which is known per se, by means for example of gel permeation chromatography (GPC), the measurement taking place preferably in DMF with polyethylene glycols, preferably, being employed as reference material (cf., inter alia, Burgath et al. in Macromol. Chem. Phys., 201 (2000) 782-91). In this context it is judicious to use a calibration plot obtained favourably using polystyrene standards. These parameters therefore constitute apparent measured values.

Alternatively the number-average molecular weight can also be determined by vapour or membrane osmosis, which are described in more detail in, for example, K. F. Arndt; G. Müller; Polymercharakterisierung; Hanser Verlag 1996 (vapour pressure osmosis) and H.-G. Elias, Makromoleküle Struktur Synthese Eigenschaften, Hütig & Wepf Verlag 1990 (membrane osmosis). GPC, however, has proven very particularly appropriate in accordance with the invention.

The polydispersity Mw/Mn of preferred hyperbranched polyurethanes is preferably in the range of 1-50, more favourably in the range of 1.1-40, in particular in the range of 1.2-20, preferably up to 10.

The viscosity of the hyperbranched polyurethanes is preferably less than 10 000 Pas, more preferably less than 5000 Pas, with particular preference less than 1000 Pas. It is measured judiciously in accordance with DIN 53018, preferably at 150° C. under a shear rate of 30 Hz, between two 20 mm plates.

The degree of branching of the hyperbranched polyurethane is judiciously in the range from >10.0% to <85.0%, preferably in the range from >20.0% to 75.0%, in particular in the range from >25.0% to 65.0%.

The degree of branching can be determined by the method of Frey. A precise description of this method can be found is D. Hölter, A. Burgath, H. Frey, Acta Polymer, 1997, 48, 30 and H. Magnusson, E. Malmström, A. Hult, M. Joansson, Polymer 2002, 43, 301.

Moreover, the hyperbranched polyurethane preferably has a glass transition temperature or melting temperature, determined by means of DSC, of less than 300° C., more preferably less than 250° C., in particular less than 200° C.

For determining the melting temperature and the glass transition temperature it has proven to be particularly favourable to use a Mettler DSC 27 HP with a heating rate of 10° C./min.

In the course of the preparation the molecular weight of the hyperbranched polyurethane can be controlled through the relative proportion of the monomers. In order to obtain very high molecular weights, the ratio in which diisocyanates or polyisocyanates are used relative to triol of the formula (1) is selected, taking into account any further comonomers present, preferably in such a way that the ratio (in mol) of the reactive groups to one another, i.e. the ratio of the isocyanate groups to the hydroxyl groups, is extremely close to 1, preferably in the range from 5:1 to 1:5, more preferably in the range from 4:1 to 1:4, with particular preference in the range from 2:1 to 1:2, even more preferably in the range from 1.5:1 to 1:5.1, and preferably in the range from 1.01:1 to 1:1.01.

The reaction of the monomers to give the desired hyperbranched polyurethane may take place in one stage or else in a multiplicity of stages (stepwise). In the case of the multistage procedure it is preferred first to take one monomer and then to add the second monomer in steps and/or to raise the reaction temperature in steps or continuously.

Preferably the reaction takes place at a temperature in the range from −80° C. to 180° C., more preferably at −40° C. to 150° C.

The monomers can be reacted in the absence of catalysts. Preferably, however, the reaction is operated in the presence of at least one catalyst.

Catalysts used in this context, for the preparation of the polyurethanes, are preferably amines, ammonium compounds, organoaluminium, organotin, organotitanium, organozirconium or organobismuth compounds. Compounds which have been found especially appropriate in this context include diazabicyclooctane (DABCO), diazabicyclononene (DBN) and diazabicycloundecene (DBU), titanium tetrabutoxide, dibutyltin dilaurate, zirconium acetylacetonate, and mixtures thereof.

The catalyst is favourably added in an amount of 50 to 10 000, preferably of 100 to 5000 ppm by weight, based on the amount of triol of the formula (1) employed.

To terminate the intermolecular polyaddition reaction there are a variety of possibilities. By way of example it is possible to lower the temperature to a range in which the addition reaction comes to a standstill and the polyaddition product is stable on storage.

For terminating the polyaddition reaction, in one preferred embodiment, an at least difunctional component which is reactive with isocyanates is added. In a further embodiment the polyaddition reaction is terminated by addition of a monofunctional component which is reactive with NCO and/or hydroxyl groups.

The reaction of the monomers can be carried out in bulk (without solvent) or in the presence of a solvent. Suitable solvents are generally those which are inert towards the respective reactants. Hydrocarbons, such as paraffins or aromatics. Particularly suitable paraffins are n-heptane and cyclohexane. Particularly suitable aromatics are benzene, toluene, ortho-xylene, meta-xylene, para-xylene, xylene in the form of an isomer mixture, ethylbenzene, chlorobenzene, and ortho- and meta-dichlorobenzene. Additionally suitable are ethers, examples being diethyl ether, dioxane or tetrahydro-furan, and ketones, such as acetone, methyl ethyl ketone and methyl isobutyl ketone, for example. Further preferred solvents include ethyl acetate, butyl acetate, methoxyethyl acetate, methoxypropyl acetate, dimethylformamide, dimethylacetamide, N-methylpyrrolidone and solvent naphtha.

The amount of solvent added is in accordance with the invention at least 0.1% by weight, based on the mass of the starting materials used that are intended for reaction; preferably at least 1% by weight and more preferably at least 10% by weight.

In one preferred embodiment the reaction is carried out free from solvent.

The preparation of the hyperbranched polyurethane of the invention takes place preferably in a pressure range from 2 mbar to 20 bar, preferably under atmospheric pressure, in reactors or reactor cascades which are operated batchwise, semi-batchwise or continuously.

Through the aforementioned adjustment of the reaction conditions and, where appropriate, through the choice of the suitable solvent it is possible for the products of the invention to be processed further after their preparation, without further purification.

As and when required, the hyperbranched polyurethane obtained by the process of the invention can also be hydrophobicized, hydrophilicized or transfunctionalized. For this purpose the OH-terminated products can be reacted in whole or in part with, for example, saturated or unsaturated carboxylic acids or their OH-reactive derivatives, sulphonic acids or their OH-reactive derivatives, or compounds containing isocyanate groups.

Hydroxyl-terminated polymers can be rendered inert by reaction with monocarboxylic acids, examples being fatty acids, fluorocarboxylic acids or monoisocyanates, and/or functionalized by means of acrylic acid or methacrylic acid. In addition it is possible for this purpose to use the corresponding carboxylic acid derivatives such as anhydrides and esters, preferably methyl esters and ethyl esters. By addition reaction of alkylene oxides, such as ethylene oxide, propylene oxide and/or butylene oxide and also mixtures thereof, they can be chain-extended.

The functional groups of the polymers of the invention may if necessary be rendered inert or modified in a further step. Thus, for example, NCO-terminated polymers can be reacted wholly or partly with fatty alcohols, fluoroalcohols, fatty amines or monoalcohols containing acrylate groups, such as hydroxyethyl acrylate or hydroxymethyl methacrylate.

End-group modifications which are additionally preferred include amine, epoxide, acrylate, meth-acrylate, vinyl, silane and acetoacetate groups.

In accordance with one very particular aspect of the present invention the polyurethanes of the invention are used for preparing polyaddition products and/or polycondensation products, more preferably polycarbonates, polyurethanes, polyethers and polyamides, and mixtures thereof. They are utilized in particular as a polyfunctional core for the construction of polymers of relatively high molecular mass. Thus, for example, by adding at least bifunctional components that contain NCO-reactive or hydroxyl-reactive groups it is possible to obtain what are called “star polymers”.

For example, after modification of the hydroxyl-terminated polyaddition products of the invention with methyl 2-bromopropionate or methyl α-bromoisobutyrate, it is possible to obtain a “macroinitiator” for the polymerization of, for example, methacrylates or styrene by means of ATRP (atom transfer radical polymerization).

Further examples, which are not to be interpreted as restricting the systematic approach, are, starting from a hydroxyl-terminated hyperbranched polymer of the invention, the ring-opening polymerization of, for example, ε-caprolactone or tetrahydrofuran to give star-shaped macromolecules.

In a further preferred embodiment it is possible, by addition reaction of ionic compounds with the NCO or hydroxyl groups, to achieve a considerable increase in, among other things, the solubility of the polyurethanes of the invention in polar solvents.

The hyperbranched polyurethanes of the invention are especially suitable for coatings, films and coverings having an improved barrier effect towards gas and liquid permeation, improved mechanical properties, an improved scratch resistance, abrasion resistance, chemical resistance and/or improved easy-to-clean properties. They are therefore used with preference in coatings, paints, films and coverings. Further particularly preferred fields of application include adhesives, sealants, casting elastomers, foams and moulding compounds, the preparation of polyaddition products and/or polycondensation products, and the use of the hyperbranched polyurethanes as a carrier molecule, in particular for active substances, as an extractant, as a moulding compound, as a film or as a composite material.

The following techniques have been found to be particularly appropriate for assessing the suitability of the polyurethanes of the invention.

### 1) Scratch Resistance

Scratch resistance is the resistance of a surface towards visible, linear damage as a result of moving hard bodies which contact the surface. To assess the scratch resistance of polymeric matrices it is possible to make use, among other parameters, of the impression hardness measured by the method of Buchholz (DIN 2851) and the test with the hardness testing rod (type 318) from Erichsen. The scratch test with the hardness testing rod (type 318) from Erichsen was carried out using the number 4 engraving point (Opel-0.5 mm diameter, specific point geometry and length) using the 0 to 10 [N] spring from Erichsen. A further option for determining the hardness of a polymeric matrix is the so-called pencil hardness (ASTM D 3363).

### 2) Friction Coefficient

The friction coefficient is measured using a specially converted electrically driven film applicator. The inserted doctor blade is replaced on the moving blade mount by a plate which lies on rollers at the other end of the applicator. By means of the blade mount it is possible to move the plate, to which the sample under measurement is attached. A block of a two-dimensional felt lining is placed on the sample body and weighted with 500 g. The sample body on the plate is pulled away beneath the weight at a speed of 12 mm/s. The vertical force required to accomplish this is measured and is designated as the friction coefficient. The friction coefficient is determined 24 hours after the surface coating is cured.

### 3) Flexibility

The elasticity of a polymeric matrix can be assessed by, among other methods, determining the cupping in accordance with DIN 1520, the ball impact in accordance with ASTM D 2794-93, and the pendulum hardness in accordance with DIN 1522.

### 4) Chemical Resistance

The chemical resistance of a polymeric surface can be determined, among other methods by ASTM D 4752.

### 5) Permeability

The oxygen permeability can be measured by means of a modified ASTM (American Society for Testing and Materials) standard method, D3985-81. The water vapour permeability can be determined gravimetrically using the ASTM standard method E-96.

### General Experimental Description:

Diisocyanate (e.g. isophorone diisocyanate, IPDI) is reacted with a triol (e.g. 1,2,6-hexanetriol) to form the hyperbranched polyisocyanate. This is done by charging a three-necked flask equipped with stirrer, internal thermometer, dropping funnel and gas inlet tube with the diisocyanate and 0.01% of DBTL in 100% form (calculated on the basis of the whole) under nitrogen blanketing. Thereafter the corresponding triol, in solution in N-methylpyrrolidone (NMP), is added slowly dropwise at 25° C. Following the addition the temperature is raised to 60° C. The course of the reaction is monitored by means of the decrease in the NCO number.

### EXAMPLE 1

### Reaction (NCO:OH): 2.375 mol IPDI:1 mol 1,2,6-hexanetriol

| | |
|---|---|
| IPDI | 131.81 g |
| 1,2,6-hexanetriol | 33.50 g |
| NMP | 200.00 g |
| Total amount | 365.31 g |

The reaction is at an end at an NCO content of 5.02%.

### EXAMPLE 2

### Reaction (NCO:OH): 2.3 mol IPDI:1 mol 1,2,6-hexanetriol

| | |
|---|---|
| IPDI | 265.50 g |
| 1,2,6-hexanetriol | 69.70 g |
| NMP | 520.00 g |
| Total amount | 855.20 g |

The reaction is at an end at an NCO content of 4.07%.

### EXAMPLE 3

### Reaction (NCO:OH): 2.275 mol IPDI:1 mol 1,2,6-hexanetriol

| | |
|---|---|
| IPDI | 144.30 g |
| 1,2,6-hexanetriol | 38.29 g |
| NMP | 200.00 g |
| Total amount | 382.59 g |

The reaction is at an end at an NCO content of 4.85%.

### EXAMPLE 4

### Reaction (NCO:OH): 2.275 mol IPDI:0.5 mol 1,2,6-hexanetriol and 0.5 mol trimethylolpropane (TMP)

| | |
|---|---|
| IPDI | 144.30 g |
| TMP | 19.15 g |
| 1,2,6-hexanetriol | 19.15 g |
| NMP | 200.00 g |
| Total amount | 363.45 g |

The reaction is at an end at an NCO content of 4.85%.

Hyperbranched polyisocyanate from IPDI/triol/diol:

### General Experimental Description:

Diisocyanate (e.g. isophorone diisocyanate, IPDI) is reacted with a triol (e.g. 1,2,6-hexanetriol) and a diol (e.g. 1,6-hexanediol) to form the hyperbranched polyisocyanate. This is done by charging a three-necked flask equipped with stirrer, internal thermometer, dropping funnel and gas inlet tube with the diisocyanate, in solution in tetrahydrofuran (THF), and 0.01% of DBTL in 100% form (calculated on the basis of the whole) under nitrogen blanketing. Thereafter the corresponding triol and diol, in solution in tetrahydrofuran (THF), is added slowly dropwise at 55° C.-60° C. Following the addition the temperature is raised to 60° C. The course of the reaction is monitored by means of the decrease in the NCO number.

### EXAMPLE 5

### Reaction (NCO:OH): 2.4 mol IPDI:0.9 mol 1,2,6-hexanetriol and 0.1 mol 1,6-hexanediol

| | |
|---|---|
| IPDI | 177.60 g |
| 1,2,6-hexanetriol | 40.20 g |
| 1,6-hexanediol | 3.93 g |
| THF | 200.00 g |
| Total amount | 421.73 g |

The reaction is at an end at an NCO content of 6.3%.

### EXAMPLE 6

### Reaction (NCO:OH): 2.4 mol IPDI:0.9 mol 1,2,6-hexanetriol and 0.1 mol 1,4-butanediol

| | |
|---|---|
| IPDI | 153.98 g |
| 1,2,6-hexanetriol | 34.87 g |
| 1,4-butanediol | 2.60 g |
| THF | 156.64 g |
| Total amount | 348.09 g |

The reaction is at an end at an NCO content of 6.6%.

### EXAMPLE 7

### Reaction (NCO:OH): 2.4 mol IPDI:0.9 mol 1,2,6-hexanetriol and 0.1 mol 1,2-ethanediol

| | |
|---|---|
| IPDI | 177.60 g |
| 1,2,6-hexanetriol | 40.20 g |
| 1,2-ethanediol | 2.07 g |
| THF | 200.00 g |
| Total amount | 419.87 g |

The reaction is at an end at an NCO content of 6.3%.

### EXAMPLE 8

### Reaction (NCO:OH): 2.4 mol IPDI:0.9 mol 1,2,6-hexanetriol and 0.1 mol 1,2-hexanediol

| | |
|---|---|
| IPDI | 177.60 g |
| 1,2,6-hexanetriol | 40.20 g |
| 1,2-hexanediol | 3.93 g |
| THF | 200.00 g |
| Total amount | 421.73 g |

The reaction is at an end at an NCO content of 6.3%.

### EXAMPLE 9

### Reaction (NCO:OH): 2.4 mol IPDI:0.75 mol 1,2,6-hexanetriol and 0.25 mol 1,6-hexanediol

| | | |
|---|---|---|
| IPDI | 154.7 | g |
| 1,2,6-hexanetriol | 29.2 | g |
| 1,6-hexanediol | 8.57 | g |
| NMP | 157.5 | g |
| Total amount | 394.97 | g |

The reaction is at an end at an NCO content of 7.1%.

### General Experimental Description:

Diisocyanate (e.g. isophorone diisocyanate, IPDI) is reacted with a triol (e.g. 1,2,6-hexanetriol) and/or a diol (e.g. 1,6-hexanediol) to form the hyperbranched polyisocyanate. This is done by charging a three-necked flask equipped with stirrer, internal thermometer, dropping funnel and gas inlet tube with the triol (diol), in solution in tetrahydrofuran (THF), and 0.01% of DBTL in 100% form (calculated on the basis of the whole) under nitrogen blanketing. Thereafter the corresponding diisocyanate, in solution in tetrahydro-furan (THF), is added slowly dropwise at 55° C.-60° C. Following the addition the temperature is held at 60° C. The course of the reaction is monitored by means of the decrease in the NCO number. Following complete reaction, an OH number is determined and the product is dried by means of a rotary evaporator and vacuum drying cabinet.

### EXAMPLE 10

### Reaction (NCO:OH): 1.0 mol IPDI:1.3 mol 1,2,6-hexanetriol

| | |
|---|---|
| IPDI | 77.77 g |
| 1,2,6-hexanetriol | 60.97 g |
| THF | 335.00 g |
| Total amount | 473.74 g |

The reaction is at an end at an NCO content of <0.01% and an OH number of 80 mg KOH/g.

### EXAMPLE 11

### Reaction (NCO:OH): 1.0 mol IPDI:1.07 mol 1,2,6-hexanetriol:0.13 MOH 1,6-hexanediol

| | |
|---|---|
| IPDI | 66.60 g |
| 1,2,6-hexanetriol | 43.01 g |
| 1,6-hexanediol | 4.60 g |
| THF | 250.00 g |
| Total amount | 364.21 g |

The reaction is at an end at an NCO content of <0.01% and an OH number of 66 mg KOH/g.

### EXAMPLE 12

### Reaction (NCO:OH): 1.0 mol IPDI:0.96 mol 1,2,6-hexanetriol:0.24 MOH 1,6-hexanediol

| | |
|---|---|
| IPDI | 66.60 g |
| 1,2,6-hexanetriol | 38.59 g |
| 1,6-hexanediol | 8.50 g |
| THF | 250.00 g |
| Total amount | 363.69 g |

The reaction is at an end at an NCO content of <0.01% and an OH number of 68 mg KOH/g.

### General Experimental Description:

A three-necked flask equipped with stirrer, internal thermometer, dropping funnel and gas inlet tube is charged with the diisocyanate, tetrahydrofuran (THF) and 0.005% of DBTL in 100% form (calculated on the basis of the whole amount) under nitrogen blanketing. Thereafter a mixture of 1,2,6-hexanetriol and 1,4-butanediol, in solution in 100 g of THF, is added slowly dropwise at 4° C. Following complete addition the mixture is stirred at room temperature for 2 h.

Thereafter the temperature is raised to 60° C. The course of the reaction is monitored by means of the decrease in the NCO number.

### EXAMPLE 13

### IPDI: hexanetriol (2.4:1) blend with 1,2-butanediol (75:25)

Reaction (NCO:OH): 2.4 mol IPDI:1 mol 1,2,6-hexane-triol, 1,4-butanediol

| | | |
|---|---|---|
| IPDI | 533.5 | g (in 400 g THF) |
| 1,2,6-hexanetriol | 100.5 | g |
| 1,4-butanediol | 22.5 | g |
| Total amount of THF | 500.00 | g |
| Total amount | 1156.5 | g |

The reaction is at an end at an NCO content of 7.3%.

### EXAMPLE 14

### IPDI: H12MDI (75:25)

Reaction (NCO:OH): 1.875 mol IPDI, 0.625 mol H12MDI:1 mol 1,2,6-hexanetriol

| | | |
|---|---|---|
| IPDI | 416.4 | g (in 300 g THF) |
| H12MDI | 163.8 | g (in 300 g THF) |
| 1,2,6-hexanetriol | 134.0 | g (in 200 g THF) |
| Total amount of THF | 800.00 | g |
| Total amount | 1514.2 | g |

The reaction is at an end at an NCO content of 5.5%.

### EXAMPLE 15

### IPDI:H12MDI (50:50)

### Hyperbranched Polymer NCO:

Reaction (NCO:OH): 1.2 mol IPDI, 1.2 mol H12MDI:1 mol 1,2,6-hexanetriol

| | | |
|---|---|---|
| IPDI | 266.4 | g (in 300 g THF) |
| H12MDI | 314.4 | g (in 300 g THF) |
| 1,2,6-hexanetriol | 134.0 | g (in 200 g THF) |
| Total amount of THF | 800.00 | g |
| Total amount | 1514.8 | g |

The reaction is at an end at an NCO content of 4.97%.

1. A hyperbranched polyurethane obtainable by reacting a diisocyanate or polyisocyanate with a triol of the formula (I) 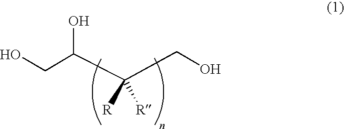
where R and R″ each independently of one another are hydrogen or an alkyl group having 1 to 4 carbon atoms and where n is an integer greater than 2,
and if desired with at least one further diol or polyol,
characterized in that the polyurethane has a numerical average of at least 4 repeating units of the formula (2) per molecule

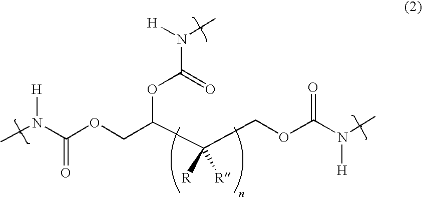

2. A polyurethane according to claim 1, characterized in that n is between 3 and 10.

3. A polyurethane according to claim 2, characterized in that n is 3 and R and R″ are hydrogen.

4. A polyurethane according to claim 1, obtainable from an aromatic, aliphatic, cycloaliphatic or (cyclo)aliphatic diisocyanate or polyisocyanate alone or in mixtures and/or oligoisocyanates and/or polyisocyanates containing urethane, allophanate, urea, biuret, uretdione, amide, isocyanurate, carbodiimide, uretonimine, oxadiazinetrione or iminooxadiazinedione structures.

5. A polyurethane according to claim 4, obtainable from
isophorone diisocyanate (IPDI),
hexamethylene diisocyanate (HDI),
diisocyanatodicyclohexylmethane (H₁₂MDI),
2-methylpentane diisocyanate (MPDI),
2,2,4-trimethylhexamethylene diisocyanate/2,4,4-trimethylhexamethylene diisocyanate (TMDI),
norbornane diisocyanate (NBDI).

6. A polyurethane according to claim 1, obtainable by reacting a diisocyanate or polyisocyanate with a triol of the formula (1) and at least one diol selected from ethylene glycol, diethylene glycol, triethylene glycol, polyethylene glycol, propylene glycol, dipropylene glycol, tripropylene glycol, polypropylene glycol, 1,2-propanediol, 1,2-butanediol and 1,3-butanediol.

7. A polyurethane according to claim 6, obtainable by reacting a diisocyanate or polyisocyanate with a mixture containing, based in each case on its total weight, 50.0% to <100.0% by weight of triol of the formula (1) and >0.0% to 50.0% by weight of diol.

8. A polyurethane according to claim 1, obtainable from a monomer mixture having a molar ratio of hydroxyl groups to isocyanate groups in the range from 5:1 to 1:5.

9. A polyurethane according to claim 1, having a weight-average molecular weight in the range from 1000 to 200 000 g/mol.

10. A polyurethane according to claim 1, having a glass transition temperature or melting temperature, measured by DSC, of less than 300° C.

11. A polyurethane according to claim 1, having a degree of branching, DB, according to Frey of 10%<DB<85.0%.

12. A polyurethane according to claim 1, characterized in that the end groups of the polymer are at least partly modified.

13. A polyurethane according to claim 12, characterized in that the end groups are hydrophobicized, hydrophilicized and/or trans-functionalized.

14. A polyurethane according to claim 13, characterized in that the end groups have been reacted with fatty acids, fatty alcohols, acrylic acid, methacrylic acid, acrylic esters and/or methacrylic esters.

15. A polyurethane according to claim 13, characterized in that the end groups are covalently bonded to polymers which can be obtained by polycondensation, polyaddition, polyaddition, anionic polymerization, cationic polymerization, free-radical polymerization and/or ring-opening polymerization.

16. The method of using the polyurethane according to claim 1 as an ingredient of printing inks, adhesives, coatings, varnishes, coverings, sealants, casting elastomers, foams and moulding compounds.

17. The method of using the polyurethane according to claim 16 for preparing polyaddition products and/or polycondensation products.

18. The method of using the polyurethane according to claim 16 as a carrier molecule, as an extractant, as a moulding compound, as a film or as a composite material.
